(19) United States
(12) Patent Application Publication
(10) Pub. No.: US 2025/0037609 A1
(43) Pub. Date: Jan. 30, 2025

(54) APPARATUS FOR SIMULATING A GYNAECOLOGICAL EXAMINATION

(71) Applicants: UNIVERSITÉ PARIS CITÉ, Paris (FR); UNIV PARIS XIII PARIS-NORD VILLETANEUSE, Villetaneuse (FR); ASSISTANCE PUBLIQUE - HOPITAUX DE PARIS, Paris (FR)

(72) Inventors: Pierre François Ceccaldi, Paris (FR); Nicoline Hjort Larsen, Paris (FR); Vincent Lemarteleur, Tronville-en-Barrois (FR); Sid-Ahmed Remini, Clichy-sous-Bois (FR)

(21) Appl. No.: 18/714,062

(22) PCT Filed: Nov. 29, 2022
(86) PCT No.: PCT/FR2022/052193

§ 371 Date: May 28, 2024

(30) Foreign Application Priority Data
Nov. 29, 2021 (FR) FR2112641

(51) Int. Cl. G09B 23/28

(52) U.S. Cl. CPC G09B 23/281

(57) ABSTRACT

Apparatus (1) for simulating a gynaecological examination, configured to simulate different configurations of cervical effacement, comprising:—a corolla (3) extending in a plane (P) perpendicular to an axis (X) and configured to simulate the feel of a vaginal wall, and—a member (5) configured to simulate a tactile sensation of a cervix, the corolla (3) extending radially on the outside of the member (5) with respect to the axis (X), the member (5) being mounted movably with respect to the corolla (3) along the axis (X), such that the member (5) is configured to move in translation along the axis (X) between:—a reference configuration, in which the member (5) extends entirely towards the outside of the apparatus (1) starting from the plane (P):—an effaced configuration, in which the member (5) extends entirely towards the inside of the apparatus (1) starting from the plane (P).

### FIELD OF THE INVENTION

The invention relates to an apparatus for simulating a gynaecological examination and for learning operative procedures, in particular an apparatus for simulating the female genital tract, which is an important anatomical part during a pregnancy in case of premature delivery (also called MAP) and other situations of female health monitoring.

### PREVIOUS STATE OF THE ART

Prematurity is defined as the birth of a living child before 37 weeks of amenorrhea. It affects more than 15 million children per year worldwide. It exposes the child to an increased risk of morbidity, in particular of respiratory or neurological morbidity, and of neonatal death when the health personnel is not trained to the specific care required for a premature baby.

There are emergency situations, such as a MAP during a pregnancy, where the training of the health personnel makes it possible to diagnose and take in charge a prematurity condition soon enough to mitigate the risks.

This training notably requires the use of simulations apparatuses that imitate a patient or an anatomical part of a patient (also called task trainers, because they are systems for training to a task or a gesture). In gynaecology and obstetrics, dedicated simulators make it possible to simulate emergency clinical or daily situations relative to pregnancy, or more generally relative to gynaecological monitoring.

The training is made easier by standardized dummies, which makes them more affordable. However, these simulation tools for obstetrics remain insufficient, particularly those in relation with childbirth, or more generally with the simulation of dynamic processes.

To improve the standard of care and the prevention of premature childbirth, it is necessary to improve the educational dummies used for initial training, in particular their dynamic characteristics.

### DISCLOSURE OF THE INVENTION

The purpose of the invention is an apparatus for simulating a gynaecological examination, configured to simulate different configurations of cervical effacement, and advantageously a dynamic simulation of a condition of risk of premature childbirth.

In the context of simulation, the apparatus for simulation of a gynaecological examination is also an obstetrical apparatus, when the simulation relates to a pregnant woman.

The goal is reached in the context of the present invention thanks to an apparatus for simulating a gynaecological examination configured to simulate different configurations of cervical effacement, comprising:
a corolla extending in a reference plane perpendicular to an axis and configured to simulate the feel of a vaginal wall, and
a member configured to simulate the tactile sensation of a cervix, the corolla extending radially on the outside of the member with respect to the axis, the member being mounted movable with respect to the corolla along the axis, so that the member is configured to move in translation along the axis between:
a reference configuration, in which the member extends entirely toward the outside of the apparatus starting from the reference plane;
an effaced configuration, in which the member extends entirely toward the inside of the apparatus starting from the reference plane.

Such an apparatus is advantageously and facultatively completed by the various following characteristics, alone or in combination:
the member is configured to move in translation along the axis between intermediate configurations, where the member positions between a reference position of the member in the reference configuration and an effaced position of the member in the effaced configuration;

the member and the corolla constitute two distinct parts configured to come in contact;
the member and the corolla constitute a monobloc part;
the member and the corolla are flexible;
the apparatus comprises an intermediate part linked to the member and to the corolla, the intermediate part being configured to rotate around a direction parallel to the axis with respect to the member and to the corolla, the intermediate part comprising a thread configured to drive the member in translation along the axis in respect to the corolla;
the member and the corolla constitute a monobloc part, and the intermediate part is configured to deform by traction the monobloc part and to move the member in the apparatus from a reference position of the member in the reference configuration to an effaced position of the member in the effaced configuration, and to move the member toward the outside of the apparatus from the effaced position to the reference position;
the intermediate part moves in a helix movement and is in contact with a stand, this stand being fixed to the member to make it follow the translation movement of the intermediate part without following its rotational movement;
the apparatus comprises a cylinder-shaped body defined by the axis, the body extending along the axis from an edge of the body, the body delimiting a cavity that opens through the edge, the edge extending in the reference plane, the corolla being rigidly linked to the edge;
the body has an internal face that defines the cavity, the internal face being threaded, the intermediate part being cylinder-shaped defined by the axis, the thread of the intermediate part being a threaded external wall of the intermediate part, the threaded external wall being configured to cooperate with the threaded internal face as a screw/sleeve combination, the apparatus further comprising a stand connected to the intermediate part as a pivot link around the axis, the stand being rigidly linked to the member;
the intermediate part is a threaded rod, the thread of the intermediate part being an external wall of the threaded rod, the apparatus comprises a driving part defining a threaded hole, the threaded rod being configured to cooperate with the threaded hole of the driving part as a screw/sleeve combination, the apparatus defining a groove that extends along the axis, the groove being fixed with respect to the corolla, the driving part being positioned at least partly in the groove in order to prevent a rotation of the driving part around the axis with respect to the body, the driving part being rigidly linked to the member;
the member and the corolla are made of silicone.

The invention also relates to a system for simulating a gynaecological examination, comprising an apparatus as described above and a device configured to simulate the feel of a vagina, the device comprising a cavity configured to receive the apparatus, the device and the apparatus being configured to be rigidly linked.

Eventually, the invention relates to a process to simulate a gynaecological examination, wherein the process comprises the movement of member of an apparatus along an axis, the apparatus being an apparatus for simulating a gynaecological examination as described above, the member being configured to simulate the feel of a cervix, the movement being relative to a corolla of the apparatus, the corolla being configured to simulate the feel of a vaginal wall, the corolla extending in a reference plane perpendicular to the axis, the corolla extending radially on the outside of the member with respect to the axis, the movement moving the member from a reference configuration, where the member adopts a reference position, where the member fully extends to the outside of the apparatus from the reference plane, to an effaced configuration, where the member adopts an effaced position, where the member fully extends to the inside of the apparatus from the reference plane.

Such an process is advantageously and facultatively completed by the various following characteristics, alone or in combination:
the movement moves the member through intermediate configurations, where the organ adopts a position between the reference position and the effaced position, the member being able to adopt positions between these two positions.
a step of touch recognition of the reference configuration, and/or a step of touch recognition of the effaced configuration, and/or a step of touch recognition of at least an intermediate configuration.

### DESCRIPTION OF THE FIGURES

Other characteristics and advantages of the invention shall also appear from the following description, which is only illustrative and non-limitative, and shall be read with reference to the appended pictures, where:

FIGS. 1 and 2 are schematic views of two configurations of an apparatus according to a first embodiment of the invention;

FIG. 3 is a schematic cross-sectional view of an apparatus according to a second embodiment of the invention;

FIG. 4 is a schematic cross-sectional view of an apparatus according to a third embodiment of the invention; and

FIG. 5 is a schematic view of a system for simulating a gynaecological examination.

### DETAILED DESCRIPTION OF THE INVENTION

### Apparatus for Simulating a Gynaecological Examination

A first purpose of the invention is an apparatus that simulates a part of the anatomy of a woman, pregnant or not, and is designed to simulate a medical gynaecological examination. In particular, this apparatus simulates an anatomical zone that comprises a cervix and a bottom of the vaginal vault around the cervix.

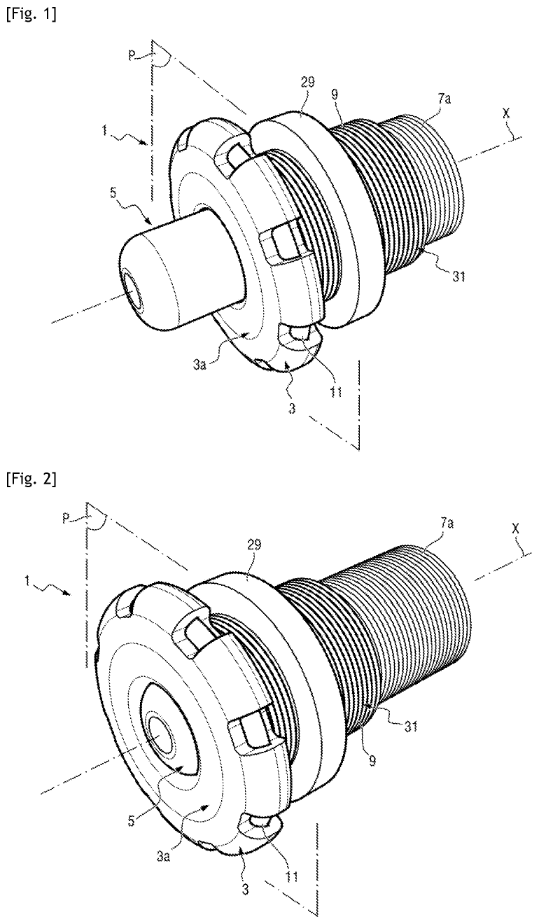

FIGS. 1 and 2 show an apparatus 1 for simulating a gynaecological examination according to a first embodiment.

The apparatus 1 comprises a corolla 3 that extends in a reference plane P perpendicular to an axis X. The corolla 3 is crossed by the reference plane P or the reference plane P is tangent to the corolla 3.

The corolla extends radially around the axis X.

The corolla is configured to simulate the feel of a vaginal wall. For this purpose, the corolla can be made of silicone.

The corolla simulates the feel on a part 3a of its outside surface. This part can be a ring-shaped zone that extends perpendicular to the axis X between an inner circle and an outer circle, wherein the two circles are centered on the axis X. The inner circle has a diameter of ca. 50 mm. The outer circle has a diameter of ca. 100 mm.

The apparatus 1 also comprises a member 5 configured to simulate the feel of a cervix. For this purpose, the member 5 can be made of silicone. The member 5 and the corolla 3 are flexible and deformable. In particular, they can have a Young's modulus less than 100 MPa.

The member has a length along the axis X between 35 mm and 45 mm.

The member 5 simulates the feel on a part of its outer surface that has an outer cylindric shape defined by the axis X. The member 5 has an outer diameter around the axis X between 35 and 50 mm. The member 5 has a distal part toward the outside of the apparatus and a proximal part toward the inside of the apparatus. An end of the distal part and an end of the proximal part are separated by the length of the member 5 along the axis X. The member 5 comprises a channel that simulates the cervical canal, which extends along the axis X.

The corolla 3 extends radially on the outside of the member 5 with respect to the axis X.

The corolla 3 and the member 5 simulate the feel of a vaginal wall or of a cervix on a same side of the apparatus and define together a touch-sensitive surface of the apparatus. This touch-sensitive surface can be accessed by the hand of an operator from a side of the reference plane called palpation side, wherein the hand moves toward the apparatus along the axis X in a direction called palpation direction.

The member 5 is mounted movably with respect to the corolla 3 along the axis X. This means that the member 5 is configured to move in translation along the axis X with respect to the corolla 3. In other words, the member 5 can be moved with respect to the corolla 3 with a movement of translation parallel to the axis X.

The feature of mobility allows the member 5 to adopt two configurations.

In a first configuration called reference configuration, the member 5 extends entirely toward the outside of the apparatus starting from the reference plane. In other words, the whole length of the member 5 along the axis X is located on one side of the reference plane called palpation side. In this reference configuration, a maximal distance along the axis X between the member 5 and the reference plane is at least equal to the length of the member 5. This maximal distance can match the distance between the end of the distal part of the member 5 and the reference plane.

The first reference configuration, as shown in FIG. 1, simulates the anatomy of a pregnant woman that cannot initiate a process of childbirth (parturition).

In a second configuration called intermediate configuration, the member 5 partly extends toward the outside of the apparatus from the reference plane, so that the distance between the distal end of the member 5 and the reference plane is equal to ca. 25 mm, which means that this distance is between 30 mm and 20 mm.

This second intermediate configuration simulates the anatomy of a pregnant woman with a possibility to initiate a childbirth process of 33%.

Advantageously, there may be several intermediate configurations. In each of these configurations, the member 5 adopts an intermediate position that can be defined by the distance between the end of the distal part of the member 5 and the reference plane. This distance can be equal to ⅛, ⅙, ⅕, ¼, ⅖, ⅓, ⅜, ½, ⅗, ⅝, ¾, ⅘, ⅚, or ⅞ of the length of the member 5. This length of the member 5 along the axis X is between 35 mm and 45 mm. The intermediate position is given by the distance between the end of the distal part of the member 5 and the reference plane that can be equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, or 44 mm.

Advantageously, the distance between the end of the distal part of the member 5 and the reference plane can be any value not more than the length of the member 5.

In a third configuration called effaced configuration, the member 5 extends entirely toward the inside of the apparatus starting from the reference plane.

In other words, the whole length of the member 5 along the axis X is located on one side of the reference plane opposite to the palpation side. This distal part of the member 5 is flush with the corolla and the reference plane. In this effaced configuration, a minimal distance along the axis X between the member 5 and the reference plane is less than 5 mm. This minimal distance can match the distance between the end of the distal part of the member 5 and the reference plane.

This third effaced configuration, as shown in FIG. 2, simulates the anatomy of a pregnant woman who is going to initiate a process of childbirth.

Finally, in a fourth configuration called labour stage, the member 5 fully extends toward the inside of the apparatus, so that the distance between the end of the distal part of the member 5 and the reference plane is equal to ca. 5 mm, which means that this distance is between 5 mm and 10 mm.

In this fourth configuration of labour stage, the member 5 is out of reach of the palpation, leaving the corolla 3 mounted on the edge 11 uncovered along the internal diameter. This configuration, where the diameter of the corolla, is dilated up to max. 40 mm, simulates the anatomy of a pregnant woman in labour.

In this simulation apparatus, the member 5 movably mounted with respect to the corolla 3 makes it possible to simulate, with only one apparatus, the two “reference” and “effaced” configurations, but the “intermediate” and “labour” configurations as well.

The apparatus also makes it possible to dynamically simulate the transition from a configuration to another.

For example, the transition from the reference configuration to the effaced configuration in circa twenty minutes is a possible sign of a MAP.

The apparatus alone makes it possible to simulate an emergency MAP condition, and it is not required, as in the state of the art, to call for two distinct objects that each simulate a configuration.

In particular, in the case where the apparatus is mounted on a dummy, it is possible to simulate an emergency MAP condition without any step of mechanical replacement of an apparatus necessary to switch from a configuration to another. To provide an implementation as immersive as possible, the apparatus is provided with MAP scenarios and various contextual documents, such as a simulated record of uterine contractions.

The apparatus 1 is configured so that the member 5 can move with respect to the corolla 3 along the axis X along a course not shorter than the length of the member 5, wherein said length can be between 35 mm and 45 mm. The apparatus 1 can advantageously comprise an engine configured to move the member in respect with the corolla along the axis X. The engine can notably be monitored remotely with a Bluetooth link or another type of wireless link.

The corolla 3 extends radially around the member 5 and is in contact with the member 5 along a circular zone centered on the axis X.

The member 5 and the corolla 3 can either constitute a monobloc part or constitute two distinct parts.

In the case where the member 5 and the corolla 3 constitute a monobloc part, this monobloc part is flexible and deformable enough for the member 5 to move with respect to the corolla 3 along the axis X along a course not shorter than the length of the member 5.

In the case where the member 5 and the corolla 3 constitute two distinct parts, these distinct parts are configured to be in contact, no matter the position of the member 5 in respect with the corolla 3. This way, the simulation of the feel at the junction between the member 5 and the corolla 3 is close to the feel in the equivalent gynaecological anatomical zone around the cervix.

In particular, the member 5 and the corolla 3 can be configured, so that the corolla exerts a friction force onto the member 5, in order to prevent a rotation around the axis X of the member 5 in respect with the corolla 3.

Various embodiments are possible to mount the member 5 movable in respect with the corolla 3 along the axis X.

The member 5 can be driven by any system that allows a translation movement along the axis X, such as a rack and pinion or an actuator system.

The translation movement of the member 5 along the axis X in respect with the corolla 3 can also be obtained if the apparatus comprises an intermediate part 7a, 19 that is linked to the member 5 and the corolla 3. The intermediate part 7a, 19 is configured to rotate around a direction parallel to the axis X in respect with the member 5 and with the corolla 3.

The intermediate part 7a, 19 comprises a thread configured to drive the member 5 in translation along the axis X in respect with the corolla 3.

The thread of the intermediate part 7a, 19 extends around the axis X or around an intermediate axis parallel to the axis X.

When the member 5 and the corolla 3 constitute a monobloc part, it is deformable and the intermediate part 7a, 19 is configured to deform by traction the monobloc part and to move the member 5 in the apparatus 1 from a reference position of the member 5 in the reference configuration to an effaced position of the member 5 in the effaced configuration, and to move the member 5 toward the outside of the apparatus 1 from the effaced position to the reference position.

In other words, in this case, the member 5 is configured to be deformed by traction of the intermediate part 7a, 19 and:
to be drawn into the apparatus 1 along the direction of movement from the reference configuration toward the effaced configuration, and.
to be extended out of the apparatus 1 along the direction of movement from the effaced configuration toward the reference configuration.

The intermediate part 7a, 19 can be rotatively driven around a direction parallel to the axis X in respect with the corolla 3, which drives the thread in the same rotation.

This rotatively movable thread can cooperate with a second thread configured not to rotate, with a screw/sleeve combination.

Thanks to this combination, the rotation around the axis X of the intermediate part gives a movement of translation between the rotatively mobile thread and the rotatively fixed thread. The apparatus can be configured so that this movement of translation drives the member 5 in respect with the corolla 3.

This link also allows a continuous movement of the member 5 between the reference configuration and the effaced configuration. The translation movement of the member 5 can be stopped at any intermediate position, so that the distance between the end of the distal part of the member 5 and the reference plane can be any value not more than the length of the member 5.

For example, the intermediate part 7a can move in a helix movement and be in contact with a stand 7b fixed to the member 5 to make it follow it, this means make the member 5 follow the translation movement of the intermediate part 7a without following its rotational movement.

In other words, the intermediate part 7a can move in a helix movement and be in contact with a stand 7b fixed to the member 5, so that the helix movement of the intermediate part 7a drives the member 5 in a translation movement without a rotation.

The helix movement of the intermediate part is the composition of a translation movement and of a rotation movement, wherein only the translation movement is transmitted to the member 5.

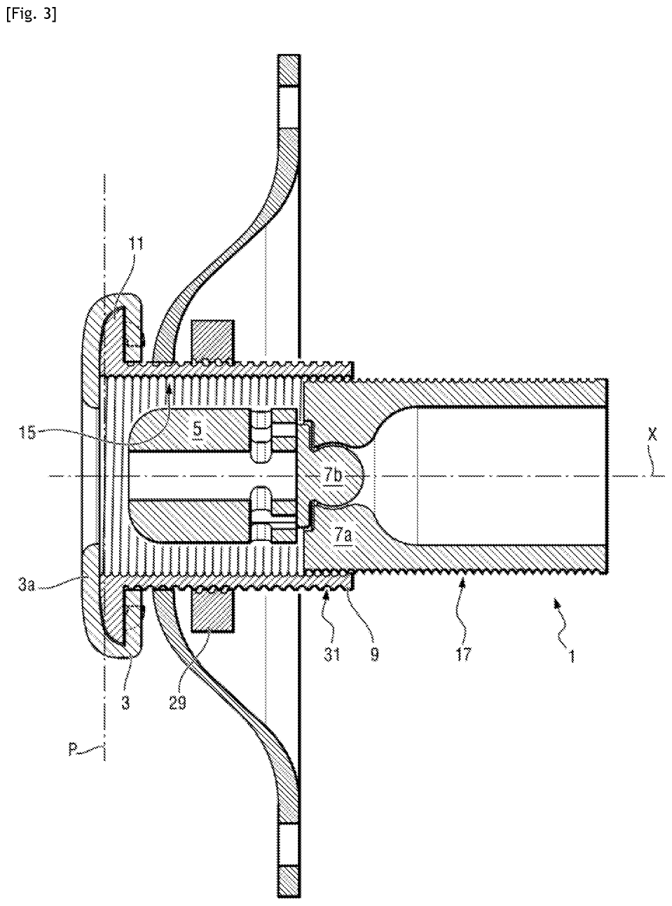

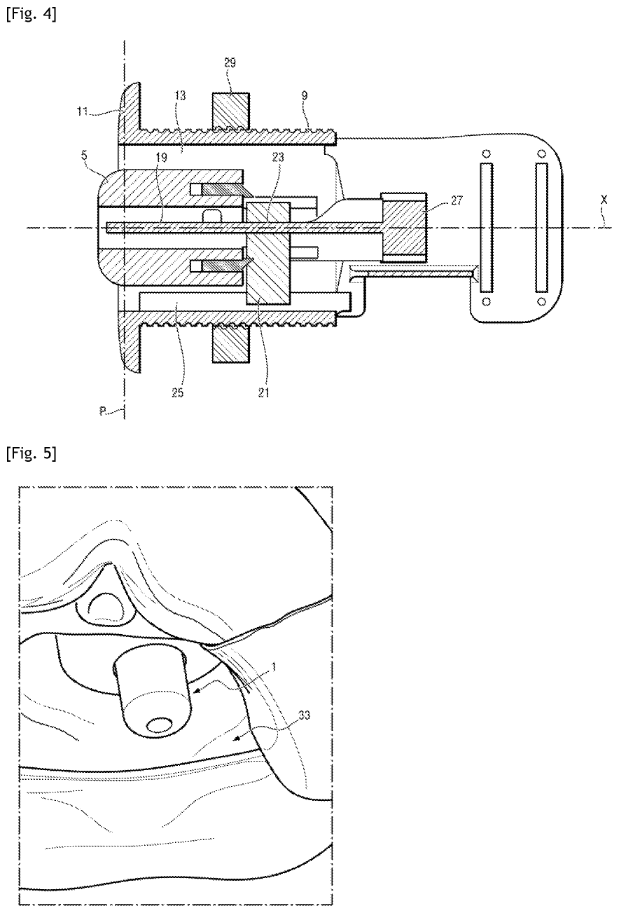

As an option for the embodiment, where the apparatus comprises an intermediate part, and in relation with FIGS. 3 and 4, the apparatus can further comprise a cylinder-shaped body 9 defined by the axis X, wherein the body extends along the axis X from an edge 11.

The body 9 can comprise a cylinder-shaped part with a circular cross-section around the axis X extending along the direction of the axis X until an edge 11.

The edge 11 can be ring-shaped extending radially on the outside with respect to the axis X from the cylinder-shaped part with circular cross-section.

The edge 11 extends in the reference plane P.

The edge 11 have a front face, on the palpation side, and a rear face, on the opposite side of the palpation.

The edge 11 is located at an end of the body 9 in an outside direction, wherein the outside direction is opposite to the palpation direction.

The body 9 extends only on one side of the reference plane P opposite to the palpation side.

The corolla 3 is rigidly linked to the edge 11.

The corolla 3 extends radially against the front side of the edge 11 on the palpation side of the reference plane.

The corolla comprises an inner surface against the front side, wherein the part 3a of the outside surface of the corolla 3 that simulates the feel is opposite to this inner surface.

The corolla can be folded against the rear face of the edge 11, which means that the corolla extends radially toward the outside from the front face beyond the edge 11. It is plated against an outer periphery of the edge 11, then extends radially toward the axis X and against the rear side of the edge 11, opposite to the palpation side. The clamping of the corolla to the edge 11 can be located on the rear side.

FIGS. 1 and 2 illustrate such an overlapping of the edge 11 by the corolla 3.

The body 9 delimits a cavity 13 that opens through the edge 11. The cavity is located on the side of the reference plane P opposite to the palpation side.

In a particular embodiment, the edge 11 has fixing elements and the corolla 3 has several openings, designed to receive each a clamping element, so that the corolla 3 is maintained by traction to the edge 11. Advantageously, the corolla 3 has the following structure:
a plane surface that covers the whole first side of the edge 11, the plane surface showing the anatomic vaginal extension of the cervix;
lugs (the petals of the corolla 3) on the ends of the plane surface that have each an opening,
   this structure makes it possible to fold lugs, wherein the folding makes it possible to abut the lugs against a second side of the edge 11, on which the clamping elements are located. Advantageously, clamping elements are hooks that are arranged in circle equidistant from each other, so that the tension onto the corolla 3 is equal on the whole surface.

In another embodiment, the corolla 3 is a part that incorporates the edge 11 and a part of the body 9. Since it is smaller, it can be fixed on the surface of the part 11 by its previous deformation and its secures a tension without needing hook-shaped clamping elements.

The cavity, as defined by such an apparatus, makes it possible to receive the member 5 in effaced configuration. The member 5 can be unfolded to the outside by positioning along the axis X beyond the reference plane to get the reference configuration.

In a first version of the embodiment, where the apparatus comprises a body that defines a cavity, and in relation with FIG. 3, the body 9 has an internal side 15 that defines a cavity 13, the internal side 15 being threaded. The threads of the internal face have a helical shape around the axis X. The intermediate part 7a is cylinder-shaped defined by the axis X, the thread of the intermediate part 7a being a threaded external wall 17 of the intermediate part 7a, the threaded external wall 17 being configured to cooperate with the threaded internal face 15 as a screw/sleeve combination.

The threads of the external wall 17 have a helical shape around the axis X and are complementary to the threads of the internal side 15.

The apparatus further comprises a stand 7b in connection with the intermediate part as a pivot link around the axis X. The stand 7b is centered around the axis X and is located toward the outside of the apparatus with respect to the intermediate part 7a. In other words, the stand 7b is located at an end of the intermediate part 7a in an outside direction, wherein the outside direction is opposite to the palpation direction.

The stand 7b is rigidly linked to the member, for example by bonding.

The intermediate part 7a moves in a helix movement and is in contact with a stand 7b, this stand 7b being fixed to the member 5 to make it follow the translation movement of the intermediate part 7a without following its rotational movement.

The intermediate 7a acts as a boring, while the stand 7b acts as a shaft in the pivot link between the intermediate part 7a and the stand 7b. The rotations along the other axes are minimal. The rotation around the axis X of this pivot link is thwarted by the interaction between the member 5 and the corolla 3; since the member 5 and the stand 7b are solidary, it remains only with a movement of translation.

In this first version, the intermediate part 7a is configured for a helical movement around the axis X in respect with the body 9, which means with the corolla 3. The helix movement is the composition of a translation movement along the axis X and of a rotation movement around the axis X. The intermediate part 7a forces the translation movement along the axis X to the stand 7b, hence to the member 5, but not the rotation movement around the axis X.

The member 5 can be moved in translation in relation with the corolla by turning the intermediate 7a in the body 9 of the apparatus.

If the member 5 and the corolla 3 constitute a monobloc, then the rotation movement around the axis X of the stand 7b is blocked by this monobloc feature.

If the member 5 and the corolla 3 constitute two distinct parts, and the member 5 and the corolla 3 are so configured that the corolla exerts a friction force onto the member 5, in order to prevent a rotation around the axis X of the member 5 in respect with the corolla 3, then the movement of rotation around the axis X of the stand 7b is blocked by this friction.

In a second version of the embodiment, where the apparatus comprises a body that defines a cavity, and in relation with FIG. 4, the intermediate part is a threaded rod 19, the thread of the intermediate part being an external wall of the threaded rod.

The threaded rod 19 can extend along the axis X or along an intermediate axis parallel to the axis X.

The apparatus comprises a driving part 21 that defines a threaded hole 23, the threaded rod 19 being configured to cooperate with the threaded hole 23 of the driving part 21 as a screw/sleeve combination.

The threaded hole extends along the same axis as the threaded rod, either the axis X or an intermediary axis parallel to the axis X.

The apparatus 1 defines a groove 25 that is fixed in relation with the corolla and that extends along the axis X.

The groove 25 can notably be an elevation on an internal side of the body 9 that defines the cavity.

The driving part 21 is positioned at least partly in the groove 25 in order to prevent a rotation of the driving part around the axis X with respect to the body.

The driving part 21 is rigidly linked to the member.

In this second version, the intermediate part 19 is configured to be rotatively moved around an axis parallel to the axis X, in respect with the body 9, which means with the corolla 3. The intermediate part 19 is linked as a screw/sleeve combination to the intermediate part 21. Since the movement of the intermediate part 21 is also constrained to the only translation movement along the axis X in respect with the body 9, the intermediate part 21 is driven by the threaded rod 19 along a translation movement along the axis X in respect with the body 9.

Thus, the member 5, which is linked to the intermediate part, is driven in translation along the axis X in respect with the corolla 5 by the rotation of the threaded rod 19.

As an option of the second version, the threaded rod 19 can be rotated by an engine 27, for example an stepping engine.

As an option of the shown various embodiments with a body comprising a cavity, the apparatus can advantageously comprise a ring with internal thread.

FIG. 3 shows such a ring 29.

The threads of the internal threading have a helical shape around the axis X. The body 9 comprises a threaded external wall 31 and configured to cooperate with the ring as a screw/sleeve combination along the axis X.

The threads of the external wall of the body 9 have a helical shape around the axis X and are complementary to the threads of the internal threading of the ring. The edge 11 is configured to block the course of the ring along a direction of movement with respect to the body.

To do so, and as previously mentioned, the edge 11 can have the shape of a ring that extends radially to the outside with respect to the axis X from a cylinder-shaped part with circular cross-section of the body 9, the cylinder-shaped part having a thread on the outer side of the external wall 31.

The ring 29 makes it possible to tighten the edge 11 against a wall of a reception device and to fix the apparatus against the reception device. Thus, it is possible to insert the simulation apparatus into a reception device that is a dummy simulating an anatomical zone wider than the cervical zone and incorporating this cervical zone. This clamping system makes it possible to adapt to most anatomic simulation dummies on the market.

Advantageously, the dummy is high-fi or low-fi.

FIGS. 1 and 2 illustrate an embodiment, where the apparatus comprises: a body 9 that defines a cavity and an edge 11,
an intermediate part 7a, whose thread is an external wall that cooperates with an internal side of the body 9, and
a ring 29 that is screwed on a threaded external wall 31 of the body 9.

The invention also relates to a system for simulating a gynaecological examination, comprising
an apparatus for simulating a gynaecological examination such as described above, and
a device configured to simulate the feel of a vagina,
the device comprising a cavity configured to receive the apparatus, the device and the apparatus being configured to be rigidly linked.

In a specific embodiment, a system for simulating a gynaecological examination makes it possible to hide the apparatus 1 to a user and to access manually to the member 5 through a cavity or a slot.

The device can notably be a dummy simulating an anatomical zone wider than the cervical zone and incorporating this cervical zone, the whole vaginal zone or the whole female genital tract.

The device and the apparatus can be rigidly linked together, notably through a ring, in order to fix the edge of the apparatus against a wall of the device.

FIG. 5 shows a system for simulating a gynaecological examination that comprises an apparatus 1 for simulating a gynaecological examination and a device 33 configured to simulate the feel of a vagina.

### Process for Simulating a Gynaecological Examination

An apparatus for simulating a gynaecological examination such as described above, makes it possible to implement a process according to the invention to simulate a gynaecological examination.

The process comprises a movement along the axis X of the member 5 of the apparatus 1 for simulating a gynaecological examination, wherein the movement is made in respect with the corolla 3 of the apparatus. The movement makes the member 5 pass:
from a reference configuration, in which the member 5 adopts a reference position, where the member 5 extends entirely toward the outside of the apparatus 1 starting from the reference plane P
to an effaced configuration, in which the member 5 adopts an effaced position where the member 5 extends entirely toward the inside of the apparatus 1 starting from the reference plane P.

The passage from the reference configuration to the effaced configuration in circa twenty minutes is a possible sign of MAP.

The process makes it possible to simulate an emergency MAP condition, and it is not required, as in the state of the art, to implement a step of mechanical replacement of an apparatus to pass from a configuration to another.

This movement makes it possible to offer a pedagogical training, where the apparatus is not directly visible to the relevant trainee: since they do not know the settled configuration of the apparatus, they have to identify by palpation the configuration of the apparatus, and eventually assess whether they are dealing with an emergency situation.

Facultatively, the process is configured so that the movement moves the member 5 through intermediate configurations, where the member 5 adopts a position between the reference position and the effaced position, the member 5 being able to adopt positions between these two positions.

Thus, the trainee can soon have to cope with various configurations. Then, the process advantageously comprises:
a step of touch recognition of the reference configuration, and/or
a step of touch recognition of the effaced configuration, and/or
a step of touch recognition of at least an intermediate configuration.

### Other Applications of the Apparatus for Simulating a Gynaecological Examination

The apparatus for simulating a gynaecological examination as described above is centered on an anatomical part called cervix, a lower part of the womb in continuity with the vaginal vault.

The cervix is globally cylinder-shaped when not in active process of childbirth. It is made of an external part called ectocervix that is visible and can be recognized by pelvic touch at a gynaecological examination. It is also made of an internal part or endocervix that is in continuity between the vagina and the womb.

Teaching not only the recognition of the anatomy of the cervix at a gynecological examination, but also the surgical and obstetrical care, is crucial for woman health, as much in obstetrics as in female sexual health for the prevention of the gynaecological cancers of the cervix.

The apparatus for simulating a gynaecological examination as described above can first apply to gynaecology.

The cervix is exposed to risks of carcinogenesis following exposition to the HPV virus (Human Papilloma Virus). In 2020, the cervical cancer claimed 604 000 worldwide. The screening and eradication of the cervical cancer is one of the goals of the World Health Organization. The regular examination of the cervix during a gynaecological examination makes it possible to swab the cervix, which is an examination made with prior consent of the patient thanks to a smear brush that slightly brushes the surface of the cervix and makes it possible to sample cells at the junction of the ectocervix and the endocervix.

To fight worldwide against this cancer, its screening can be made by a large population: gynaecologists, family doctors, midwives, personnel of health centers, hospitals or medical biology laboratories with medical prescription, health center nurses, even associations that intervene with the populations furthest from the health system.

The following steps, in case of need of further investigation, require an examination with a binocular magnifier or a colposcopy with guided biopsy, if required. Finally, if precancerous lesions or a cancer in situ is diagnosed, a surgical act called conization is made, which consists in removing the suspect part of the cervix.

All these medical acts, from the screening to the conization, can be simulated on the apparatus for simulating a gynaecological examination such as described above.

In rare cases of cervical cancer, and depending on their progress, a treatment consists in a local radiotherapy or brachytherapy, which consists in arranging an applicator in the vagina, said applicator receiving iridium or cesium (2) radioactive sources.

Eventually, the model can be useful to explain and teach the insertion of contraceptives with intrauterine devices or loops.

In short, for gynaecology, the apparatus for simulating a gynaecological examination as described above can apply to the simulation of:
the swabbing of the cervix,
an examination with a binocular magnifier,
a colposcopy,
a biopsy,
a conization,
a local radiotherapy or brachytherapy, and
the insertion of contraceptives with intrauterine devices or loops.

The apparatus for simulating a gynaecological examination as described above can then apply to the medical assistance for the procreation (AMP). For this kind of medical care, there is a long therapeutical time on the cervix, called intrauterine implementation.

Since the first childbirth from an in vitro fertilization (FIV) at the end of the seventies, the number of FIVs have always been increasing. In the early 2000s, nearly 300 000 attempts were made per year in Europe, with nearly a third of full-term pregnancies, varying according to the countries. Technically, for reimplantation of an embryo into the womb after the FIV procedures, it is necessary that the embryo crosses the cervix via a catheter. This therapeutical act requires some accuracy and learning by repetition and mentorship, in particular because it conditions the success of the whole AMP procedure.

In short, for the medical assistance for the procreation (AMP), the apparatus for simulating a gynaecological examination as described above can apply to the simulation of:
the fulfillment of an intrauterine implementation.

At last, the apparatus for simulating a gynaecological examination as described above can eventually apply to obstetrics.

Obstetrics notably relates to the survey and care of pregnancy, normal or not. The cervix, as an integral part of the female genital tract, is fully integrated in this care, because its normal aspect guarantees the retention in utero of the pregnancy. The normal aspect of the cervix is notably assessed by a length more than ca. 2.5 cm, by a firm consistence and by its closure at the pelvic examination. If it happens to open too much before the end of gestation, there is a risk of premature childbirth (MAP). The diagnostic and care of MAP is an obstetric emergency condition.

Teaching the health professionals about this emergency condition should allow them to diagnose and treat it soon enough to mitigate the risks of premature birth. MAP is a dynamic process of effacement of the cervix after uterine contractions. It must be quickly diagnosed to start a treatment to stop these uterine contractions. The arrest of these contractions makes it possible to stabilize the retraction of the cervix, but does not make it possible to close it or to extend it.

In some situations of opening of the cervix at the first quarter of pregnancy, it can be useful to surgically “strengthen” the cervix by a technique of uterine cerclage placement, which consists in positioning a wire around it by vaginal route or to repel the waters around the fetus before closing the cervix with a wire or a tissue tape.

In some situations, at the end of the pregnancy, around the ninth month, the cervix cannot open and it may be necessary to induce the labour. In this case, it is possible to induce the ripening of the cervix with a balloon. This technique makes it possible to favor the opening of the cervix by passing a balloon through the endocervix; the balloon will be inflated with 40 to 80 mL water and positioned above the junction between the cervix and the cervical body. This process was described in the 19^{th} century and updated a few years ago, and it is increasingly used to induce labour. On average, the balloon is left 24 hours, which guarantees the progressive mechanical opening of the cervix.

In short, for obstetrics, the apparatus for simulating a gynaecological examination as described above can apply to the simulation of:
the diagnostic of a risk of premature childbirth,
a uterine cerclage, and
a ripening of the cervix with a preparative balloon for the opening of the cervix.

1. An apparatus for simulating a gynaecological examination, configured to simulate different configurations of cervical effacement, comprising:
a corolla extending in a reference plane perpendicular to an axis and configured to simulate the feel of a vaginal wall, and a member configured to simulate the tactile sensation of a cervix, the corolla extending radially on the outside of the member with respect to the axis, the member being mounted movably with respect to the corolla along the axis, such that the member is configured to move in translation along the axis between:
a reference configuration, in which the member extends entirely toward the outside of the apparatus starting from the reference plane; and
an effaced configuration, in which the member extends entirely toward the inside of the apparatus starting from the reference plane.

2. An apparatus according to claim 1, wherein the member is configured to move in translation along the axis between intermediate configurations, where the member positions between a reference position of the member in the reference configuration and an effaced position of the member in the effaced configuration.

3. An apparatus according to claim 1, wherein the member and the corolla constitute two distinct parts configured to come in contact.

4. An apparatus according to claim 1, wherein the member and the corolla constitute a monobloc part.

5. An apparatus according to claim 1, wherein the member and the corolla are flexible.

6. An apparatus according to claim 1, comprising an intermediate part in connection with the member and with the corolla, wherein the intermediate part is configured to rotate around a direction parallel to the axis in respect to the member and to the corolla, the intermediate part comprising a thread configured to drive the member in translation along the axis in respect to the corolla.

7. An apparatus according to claim 4, wherein the member and the corolla constitute a monobloc part, and wherein the intermediate part is configured to deform by traction the monobloc part and to move the member in the apparatus from a reference position of the member in the reference configuration to an effaced position of the member in the effaced configuration, and to move the member toward the outside of the apparatus from the effaced position to the reference position.

8. An apparatus according to claim 1, wherein the intermediate part moves in a helix movement and is in contact with a stand, this stand being fixed to the member to make it follow the translation movement of the intermediate part without following its rotational movement.

9. An apparatus according to claim 1, comprising a cylinder-shaped body defined by the axis, the body extending along the axis from an edge of the body, the body delimiting a cavity that opens through the edge, the edge extending in the reference plane, the corolla being rigidly linked to the edge.

10. An apparatus according to claim 9, wherein the body has an internal face that defines the cavity, the internal face being threaded, the intermediate part being cylinder-shaped defined by the axis, the thread of the intermediate part being a threaded external wall of the intermediate part, the threaded external wall being configured to cooperate with the threaded internal face as a screw/sleeve combination, the apparatus further comprising a stand connected to the intermediate part as a pivot link around the axis, the stand being rigidly linked to the member.

11. An apparatus according to claim 9, wherein the intermediate part is a threaded rod, the thread of the intermediate part being an external wall of the threaded rod, the apparatus comprising a driving part that defines a threaded hole, the threaded rod being configured to cooperate with the threaded hole of the driving part as a screw/sleeve combination, the apparatus defining a groove that extends along the axis, the groove being fixed with respect to the corolla, the driving part being positioned at least partly in the groove in order to prevent a rotation of the driving part around the axis with respect to the body, the driving part being rigidly linked to the member.

12. An apparatus according to claim 1, wherein the member and the corolla are made of silicon.

13. A system for simulating a gynaecological examination comprising an apparatus according to claim 1, and a device configured to simulate the feel of a vagina, the device comprising a cavity configured to receive the apparatus, the device and the apparatus being configured to be rigidly linked together.

14. A process to simulate a gynaecological examination, the process comprising a movement along an axis of a member of an apparatus for simulating a gynaecological examination according to claim 1, the apparatus being configured to simulate different configurations of cervical effacement, the member being configured to simulate the feel of a cervix, the movement being relative to a corolla of the apparatus, the corolla being configured to simulate the feel of a vaginal wall, the corolla extending in a reference plane perpendicular to the axis, the corolla extending radially on the outside of the member with respect to the axis, the movement moving the member from a reference configuration, where the member adopts a reference position, where the member fully extends to the outside of the apparatus from the reference plane, to an effaced configuration, where the member adopts an effaced position, where the member fully extends to the inside of the apparatus from the reference plane.

15. A process according to claim 14, wherein the movement moves the member through intermediate configurations, where the member adopts a position between the reference position and the effaced position, the member being able to adopt positions between these two positions.

16. A process to simulate a gynaecological examination according to claim 15, further comprising:
a step of touch recognition of the reference configuration, and/or
a step of touch recognition of the effaced configuration, and/or
a step of touch recognition of at least an intermediate configuration.
